(19) United States
(12) Patent Application Publication
(10) Pub. No.: US 2016/0311689 A1
(43) Pub. Date: Oct. 27, 2016

(54) SUPERHARD CONSTRUCTIONS & METHODS OF MAKING SAME

(71) Applicants: Element Six Limited, County Clare (IE); Baker Hughes Incorporated, Houston, TX (US)

(72) Inventors: Roger William Nigel NILEN, Didcot (GB); Nedret CAN, Didcot (GB); Humphrey SITHEBE, Springs (ZA); David BOWES, Didoct (GB); Derek NELMS, Houston, TX (US)

(21) Appl. No.: 15/103,290

(22) PCT Filed: Dec. 17, 2014
(86) PCT No.: PCT/EP2014/078265

§ 371 Date: Jun. 9, 2016

Related U.S. Application Data
(60) Provisional application No. 61/917,178, filed on Dec. 17, 2013.

(51) Int. Cl. C01B 31/06; B22F 7/08; B22F 5/00; E21B 10/573

(52) U.S. Cl. CPC C01B 31/06; E21B 10/5735; B22F 7/08; B22F 5/00; B22F 2005/001

(57) ABSTRACT

A superhard construction comprises a substrate (10) comprising a peripheral surface, an interface surface (18) and a longitudinal axis and a super hard material layer (12) formed over the substrate and having an exposed outer surface forming a working surface (14), a peripheral surface extending therefrom and an interface surface. One of the interface surface of the substrate or the interface surface of the super hard material layer comprises one or more projections (24, 26) arranged to project from the interface surface, the height of the one or more projections being between around 0.2 mm to around 1.0 mm measured from the lowest point on the interface surface from which the one or more projections extend.

### FIELD

This disclosure relates to super hard constructions and methods of making such constructions, particularly but not exclusively to constructions comprising polycrystalline diamond (PCD) structures attached to a substrate and for use as cutter inserts or elements for drill bits for boring into the earth.

### BACKGROUND

Polycrystalline superhard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of superhard tool inserts may be limited by fracture of the superhard material, including by spalling and chipping, or by wear of the tool insert.

Cutting elements such as those for use in rock drill bits or other cutting tools typically have a body in the form of a substrate which has an interface end/surface and a super hard material which forms a cutting layer bonded to the interface surface of the substrate by, for example, a sintering process. The substrate is generally formed of a tungsten carbide-cobalt alloy, sometimes referred to as cemented tungsten carbide and the ultra hard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a superhard material (also called a superabrasive material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify. To form the cutting element with a super hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline super hard diamond or polycrystalline CBN layer.

In some instances, the substrate may be fully cured prior to attachment to the super hard material layer whereas in other cases, the substrate may be green, that is, not fully cured. In the latter case, the substrate may fully cure during the HTHP sintering process. The substrate may be in powder form and may solidify during the sintering process used to sinter the super hard material layer.

Cobalt has a significantly different coefficient of thermal expansion from that of diamond and, as such, upon heating of the polycrystalline diamond material during use, the cobalt in the substrate to which the PCD material is attached expands and may cause cracks to form in the PCD material, resulting in the deterioration of the PCD layer.

To reduce the residual stresses created at the interface between the substrate and the super hard layer, interface surfaces on substrates are known to have been formed with a plurality concentric annular rings projecting from the planar interface surface. Due to the difference in the coefficients of thermal expansion of the substrate and the super hard material layer, these layers contract at different rates when the cutting element is cooled after HTHP sintering. Tensile stress regions are formed on the upper surfaces of the rings, whereas compressive stress regions are formed on/in the valleys between such rings. Consequently, when a crack begins to grow in use, it may grow annularly along the entire upper surface of the annular ring where it is exposed to tensile stresses, or may grow along the entire annular valley between the projecting rings where it is exposed to compressive stresses, leading to the early failure of the cutting element.

It is also known for cutting element substrate interfaces to comprise a plurality of spaced apart projections, the projections having relatively flat upper surfaces projecting from a planar interface surface.

Common problems that affect cutting elements are chipping, spalling, partial fracturing, and cracking of the ultra hard material layer. Another problem is cracking along the interface between the super hard material layer and the substrate and the propagation of the crack across the interface surface. These problems may result in the early failure of the super hard material layer and thus in a shorter operating life for the cutting element. Accordingly, there is a need for a cutting element having an enhanced operating life in high wear or high impact applications, such as boring into rock, with a super hard material layer in which the likelihood of cracking, chipping, and fracturing is reduced or controllable.

### SUMMARY

Viewed from a first aspect there is provided a superhard construction comprising:
a substrate comprising a peripheral surface, an interface surface and a longitudinal axis; and
a super hard material layer formed over the substrate and having an exposed outer surface forming a working surface, a peripheral surface extending therefrom and an interface surface;
wherein one of the interface surface of the substrate or the interface surface of the super hard material layer comprises:

one or more projections arranged to project from the interface surface, the height of the one or more projections being between around 0.2 mm to around 1.0 mm measured from the lowest point on the interface surface from which the one or more projections extend.

Viewed from a second aspect there is provided an earth boring drill bit comprising a body having any of the aforementioned superhard constructions mounted thereon as a cutter element.

### BRIEF DESCRIPTION OF THE DRAWINGS

Non-limiting embodiments will now be described by way of example and with reference to the accompanying drawings in which:

FIG. 1 is a perspective view of a cutting element;

FIG. 2a is a perspective view of the plurality of projections of FIG. 1 in free space;

FIG. 2b is a schematic plan view of the substrate of the cutting element of FIG. 1;

FIG. 2c is a schematic cross-sectional view of the substrate along the axis A-A shown in FIG. 2b: and

FIG. 2d is a schematic perspective view of the substrate of the cutting element of FIG. 1.

### DETAILED DESCRIPTION

In the embodiments described herein, when projections or depressions are described as being formed on the substrate surface, it should be understood that they could be formed instead on the surface of the super hard material layer that interfaces with the substrate interface surface, with the inverse features formed on the substrate. Additionally, it should be understood that a negative or reversal of the interface surface is formed on the super hard material layer interfacing with the substrate such that the two interfaces form a matching fit.

As used herein, a “super hard material” is a material having a Vickers hardness of at least about 28 GPa. Diamond and cubic boron nitride (cBN) material are examples of superhard materials.

As used herein, a “super hard construction” means a construction comprising a body of polycrystalline super hard material and a substrate attached thereto.

As used herein, polycrystalline diamond (PCD) is a type of polycrystalline super hard material (PCS) material comprising a mass of diamond grains, a substantial portion of which are directly inter-bonded with each other and in which the content of diamond is at least about 80 volume percent of the material. In one embodiment of PCD material, interstices between the diamond grains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

As used herein, PCBN (polycrystalline cubic boron nitride) material refers to a type of superhard material comprising grains of cubic boron nitride (cBN) dispersed within a matrix comprising metal or ceramic. PCBN is an example of a superhard material.

A “catalyst material” for a superhard material is capable of promoting the growth or sintering of the super hard material.

The term “substrate” as used herein means any substrate over which the super hard material layer is formed. For example, a “substrate” as used herein may be a transition layer formed over another substrate. Additionally, as used herein, the terms “radial” and “circumferential” and like terms are not meant to limit the feature being described to a perfect circle.

The superhard construction 1 shown in the attached figures may be suitable, for example, for use as a cutter insert for a drill bit for boring into the earth.

Like reference numbers are used to identify like features in all drawings.

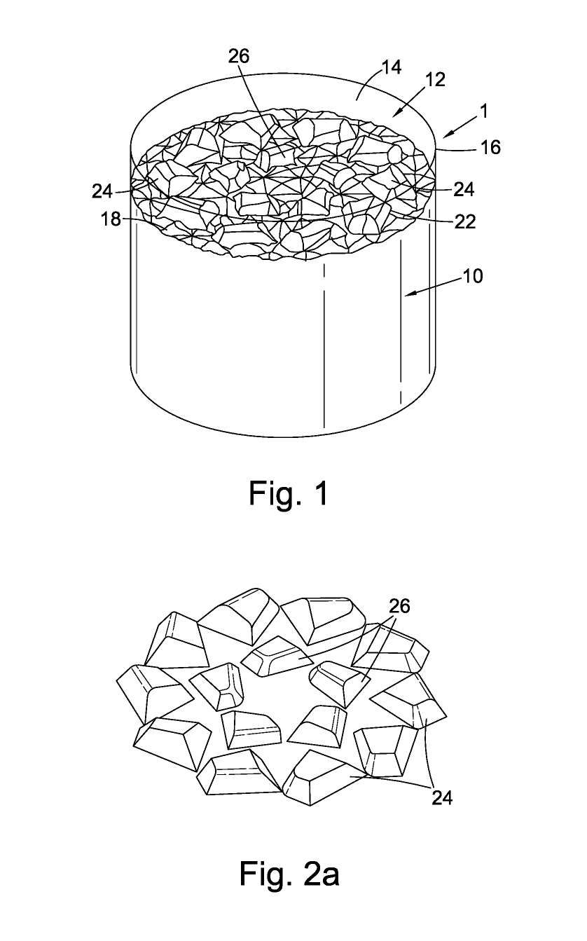

In an embodiment as shown in FIG. 1, a cutting element 1 includes a substrate 10 with a layer of super hard material 12 formed on the substrate 10. The substrate may be formed of a hard material such as cemented tungsten carbide. The super hard material may be, for example, polycrystalline diamond (PCD), polycrystalline cubic boron nitride (PCBN), or a thermally stable product such as thermally stable PCD (TSP). The cutting element 1 may be mounted into a bit body such as a drag bit body (not shown). The exposed top surface of the super hard material opposite the substrate forms the cutting face 14, which is the surface which, along with its edge 16, performs the cutting in use.

At one end of the substrate 10 is an interface surface 18 that interfaces with the super hard material layer 12 which is attached thereto at this interface surface. The substrate 10 is generally cylindrical and has a peripheral surface 20 and a peripheral top edge 22. In the embodiment shown in FIG. 1, the interface surface 18 includes a plurality of spaced-apart projections 24 that are arranged in a substantially annular first array and are spaced from the peripheral edge 22, and a second or inner substantially annular array of projections 26 that are radially within the first array 24.

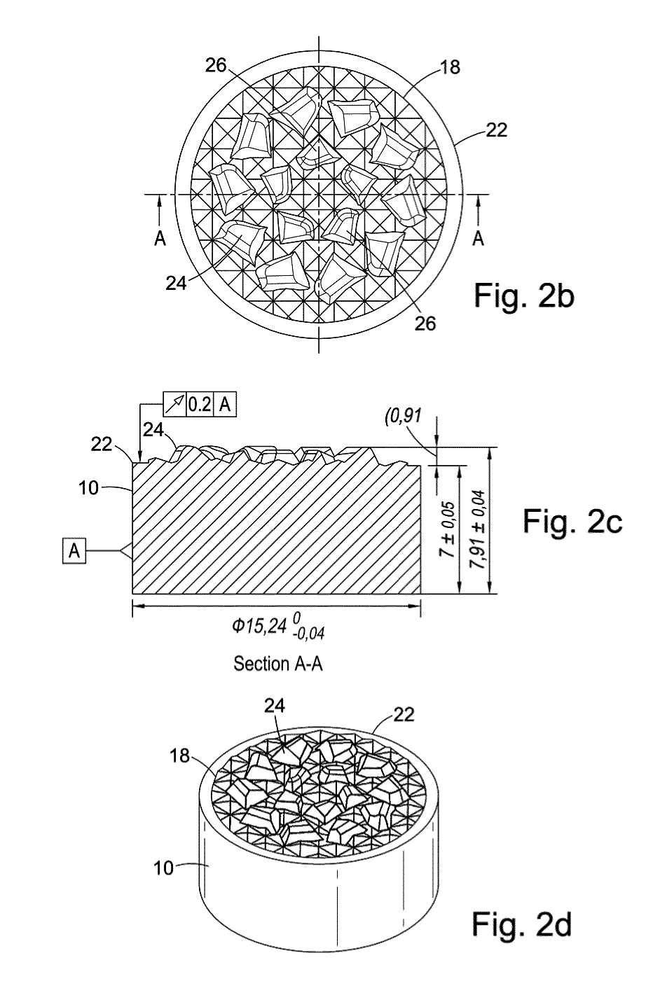

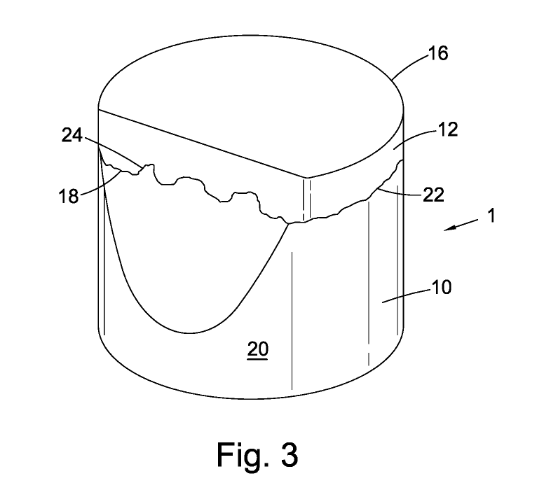

As shown in FIGS. 1 and 2a to 2d, in this embodiment the spaced-apart projections 24, 26 are arranged in two arrays which are disposed in two substantially circular paths around a central longitudinal axis of the substrate 10. However, the invention is not limited to this geometry, as, for example, the placement of the projections 24, 26 may be in an ordered non-annular array on the interface surface 18 or the projections may be randomly distributed thereon rather than in a substantially circular or other ordered array. Furthermore, in the embodiments where the projections are arranged in annular arrays, these may be elliptical or asymmetrical, or may be offset from the central longitudinal axis of the substrate 10. Also, whilst the projections 26 of the inner array are shown to be closer to the outer array 24 than to the longitudinal central axis of the substrate, in other embodiments the projections 26 of the inner array may be closer to the longitudinal central axis.

The projections 26 in the second array may be positioned to radially align with the spaces between the projections 24 in the first array. The projections 24, 26 and spaces may be staggered, with projections in one array overlapping spaces in the next array. This staggered or mis-aligned distribution of three-dimensional features on the interface surface may assist in distributing compressive and tensile stresses and/or reducing the magnitude of the stress fields and/or arresting crack growth by preventing an uninterrupted path for crack growth.

As shown in FIGS. 1 and 2a to 2d, in these embodiments, all or a majority of the projections 24, 26 are shaped such that all or a majority of the surfaces of the projections are not substantially parallel to the cutting face 14 of the super hard material 12 or to the plane through which the longitudinal axis of the substrate extends. Also, in the embodiments shown in FIGS. 1 to 2d, the interface surface 18 in the spaces between projections is uneven. This may be interpreted as, but not limited to, covering one or more of these spaces being non-uniform, varying, irregular, rugged, not level, and/or not smooth, with peaks and troughs. This arrangement is thought to act to inhibit uninterrupted crack propagation along the interface surface 18 and to increase the contact surface area between the interface of the substrate 10 and the interface of the super hard material layer 12. Furthermore, it is believed that such a configuration acts to disturb ‘elastic’ wave formation in the material and deflect cracks at the interface. These spaces or uneven valleys separating each projection 24, 26 from the adjacent projections may be uniform in some embodiments and non-uniform in other embodiments.

The projections 24, 26 may have a smoothly curving upper surface or may have a sloping upper surface. In some embodiments, the projections 24, 26 may be slightly trapezoidal or tapered in shape, being widest nearer the interface surface from which they project.

In FIGS. 1 and 2a to 2d, the projections 24, 26 are spaced substantially equally in/round the respective substantially annular array, with each projection 24, 26 within a given array having the same dimension. However, the projections 24, 26 may be formed in any desired shape, as described above, and spaced apart from each other in a uniform or non-uniform manner to alter the stress fields over the interface surface 18. The projections 24 in the outer array are, as shown in the embodiment of FIGS. 1 and 2, larger in size than those in the inner array. However, these relative sizes may be reversed, or the projections 24, 26 in both arrays could be approximately of uniform size, or a mixture of sizes.

The height of the projections 24, 26 is between around 0.2 mm to around 0.8 mm measured from the lowest point of the interface surface 18 to the maximum height of the projections 24, 26.

In the embodiment shown in FIGS. 1 and 2a to 2d, the outer array includes double the number of projections 24 than the inner layer, for example ten and five projections respectively. This permits the cutter element 1 to have pseudo axi-symmetry thereby providing freedom in positioning the cutter in the tool or drill bit in which it is to be used as it would not require specific orientation. The projections 24, 26 are positioned and shaped in such a way that they inhibit one or more continuous paths along which cracks could propagate across the interface surface 18. Also, in some embodiments, all or the majority of the projections and/or spaces therebetween do not have any surfaces which are substantially normal or parallel to any loads expected to be applied to the cutter element 1 in use, and nor which are substantially normal or parallel to any exterior surfaces thereof.

The arrangement and shape of the projections 24, 26 and spaces therebetween may affect the stress distributions in the cutting element 1 and may act to improve the cutting element's resistance to crack growth, in particular crack growth along the interface surface 18, for example by arresting or diverting crack growth across the stress zones in, around and above the projections 24, 26.

In this embodiment, all or a majority of the projections 24, 26 do not have any surface substantially parallel to either the cutting face of the super hard layer (not shown) which will be attached thereto, or the plane through which the longitudinal axis of the substrate extends. The projections 24, 26 may be all the same height or some may be of a greater height than others.

In one or more of the above-described embodiments, the features of the interface surface 18 may be formed integrally whilst the substrate is being formed through use of an appropriately shaped mold into which the particles of material to form the substrate are placed. Alternatively, the projections and uneven surfaces of the interface surface 18 may be created after the substrate has been created or part way through the creation process, for example by a conventional machining process. Similar procedures may be applied to the super hard material layer 12 to create the corresponding shaped interface surface for forming a matching fit with that of the substrate.

The super hard material layer 12 may be attached to the substrate by, for example, conventional brazing techniques or by sintering using a conventional high pressure and high temperature technique.

The durability of the cutter product including the substrate and super hard material layer with the aforementioned interface features and/or the mitigation of elastic stress waves therein may be further enhanced if the super hard material layer 12 is leached of catalyst material, either partially or fully, in subsequent processing, or subjected to a further high pressure high temperature sintering process. The leaching may be performed whilst the super hard material layer 12 is attached to the substrate or, for example, by detaching the super hard material layer 12 from the substrate, and leaching the detached super hard material layer 12. In the latter case, after leaching has taken place, the super hard material layer 12 may be reattached to the substrate using, for example, brazing techniques or by resintering using a high pressure and high temperature technique. As the height of the projections 24, 26 is between around 0.2 mm to around 1 mm, for example around 0.8 mm measured from the lowest point of the interface surface 18 to the maximum height of the projections 24, 26, this enables the super hard material layer 12 to be leached to a depth of greater than around 700 microns or even greater than around 1 mm.

Although particular embodiments have been described and illustrated, it is to be understood that various changes and modifications may be made. For example, the substrate described herein has been identified by way of example. It should be understood that the super hard material may be attached to other carbide substrates besides tungsten carbide substrates, such as substrates made of carbides of W, Ti, Mo, Nb, V, Hf, Ta, and Cr. Furthermore, although the embodiments shown in FIGS. 1 to 3 are depicted in these drawings as comprising PCD structures having sharp edges and corners, embodiments may comprise PCD structures having rounded, bevelled or chamfered edges or corners. Such embodiments may reduce internal stress and consequently extend working life through improving the resistance to cracking, chipping, and fracturing of cutting elements through the interface of the substrate or the super hard material layer having unique geometries.

1. A superhard construction comprising:
a substrate comprising a peripheral surface, an interface surface and a longitudinal axis; and
a super hard material layer formed over the substrate and having an exposed outer surface forming a working surface, a peripheral surface extending therefrom and an interface surface;
wherein one of the interface surface of the substrate or the interface surface of the super hard material layer comprises:
one or more projections arranged to project from the interface surface, the height of the one or more projections being between around 0.2 mm to around 1.0 mm measured from the lowest point on the interface surface from which the one or more projections extend.

2. The superhard construction of claim 1, wherein the height of the one or more projections is between around 0.3 mm to around 0.8 mm.

3. The superhard construction of claim 1, wherein all or a majority of the interface surface between the spaced-apart projections is non-curved and extends in one or more planes which are not substantially parallel to the plane of the exposed outer surface of the super hard material layer.

4. The superhard construction of claim 1, the substrate having a central longitudinal axis, wherein all or a majority of the interface surface between the spaced-apart projections extends in one or more planes which are not substantially parallel to a plane through which the central longitudinal axis of the substrate extends.

5. The superhard construction of claim 1, wherein the projections are arranged in one or more substantially radial arrays around the central longitudinal axis of the substrate.

6. The superhard construction of claim 5, wherein the projections are arranged in a first array and a second array, the second array being positioned radially within the first array.

7. The superhard construction of claim 6, wherein the first and second arrays are substantially concentric with the substrate.

8. The superhard construction of claim 6, wherein the first array comprises substantially double the number of projections than the second array.

9. The superhard construction of claim 6, wherein the projections in the first and second arrays are staggered relative to each other.

10. The superhard construction of claim 1, wherein the projections are randomly arranged on one of the interface surface of the substrate or the interface surface of the super hard material layer.

11. The superhard construction of claim 1, wherein one or more of the surfaces of all or a majority of the projections extend in one or more planes which are not substantially parallel to the plane of the exposed outer surface of the super hard material layer and/or in one or more planes which are not substantially parallel to a plane through which the central longitudinal axis of the substrate extends.

12. The superhard construction of claim 1, wherein the thickness of the super hard material layer about the central longitudinal axis of the substrate is substantially the same as the thickness of the super hard material layer at the peripheral surface.

13. The superhard construction of claim 1, wherein the super hard material layer comprises polycrystalline diamond material and a plurality of interstitial regions between inter-bonded diamond grains forming the polycrystalline diamond material; the super hard material layer comprising:
a first region substantially free of a solvent/catalysing material; and
a second region remote from the working surface that includes solvent/catalysing material in a plurality of the interstitial regions;
wherein the first region extends to a depth of greater than around 300 microns from the working surface into the body of polycrystalline diamond material.

14. The superhard construction of claim 13, wherein the first region extends to a depth of between around 300 microns to around 1500 microns from the working surface into the body of polycrystalline diamond material.

15. The superhard construction of claim 13, wherein the first region extends to a depth of between around 300 microns to around 1000 microns from the working surface into the body of polycrystalline diamond material.

16. The superhard construction of claim 13, wherein the first region extends to a depth of between around 600 microns to around 1000 microns from the working surface into the body of polycrystalline diamond material.

17. The superhard construction of claim 1, wherein the exposed outer surface of the super hard layer is substantially planar.

18. The superhard construction of claim 1, wherein the one or more projections are of equal height.

19. The superhard construction of claim 1, comprising a plurality of projections arranged in a first array and a second array concentrically located within the first array, wherein the projections in the first array are of a greater height than the projections in the second array.

20. The superhard construction of claim 1, wherein any interface surface between any projections or not covered by the projections is uneven.

21. (canceled)

22. (canceled)

23. (canceled)

24. (canceled)
